(19) United States
(12) Patent Application Publication
(10) Pub. No.: US 2007/0091330 A1
(43) Pub. Date: Apr. 26, 2007

(54) Printing control method and apparatus for preventing data loss

(75) Inventors: Na-Young Kim, Suwon-si (KR); Jeong-Sang Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/498,856

(22) Filed: Aug. 4, 2006

(30) Foreign Application Priority Data
Oct. 20, 2005 (KR) 2005-99329

(51) Int. Cl. G06K 15/02

(52) U.S. Cl. 358/1.2; 358/528

(57) ABSTRACT

A printing control method and apparatus for printing an entire document on printing paper without data loss is provided. A virtual paper size and document data having the virtual paper size are received, a document corresponding to the document data is displayed, and the document data of the virtual paper size is converted to printing data of a currently set printing paper size. Accordingly, when printing is performed by receiving document data from an application program that lacks a paper size editing function, the document data can be received from the application program according to a selected virtual paper size using a printing preview function, conversion to printing data of a currently set printing paper size, and printed. Thus, waste of printing paper and working time due to the printing data loss can be reduced.

### PRIORITY

This application claims the benefit under 35 U.S.C. § 119(a) of Korean Patent Application No. 10-2005-0099329, filed Oct. 20, 2005, in the Korean Intellectual Property Office, the entire disclosure of which is hereby incorporated by reference.

### FIELD OF THE INVENTION

The present invention relates to a method and apparatus for controlling printing by inputting document data from an application program in a driver of an image forming device. More particularly, the present invention relates to a printing control method and apparatus for preventing loss of printing data when an application program lacking a paper size editing function, such as a web browser, is used.

### DESCRIPTION OF THE RELATED ART

An image forming device prints documents edited by a user using an application program installed on a personal computer (PC) to convert printing data in user readable form. In general, a printer driver, which converts document data edited using the application program to printer-analyzable printing data and outputs the converted printing data to the image forming device, is installed on the PC.

A plurality of standard paper sizes are settable by the printer driver, and a user selects a standard paper size corresponding to a desired size of printing paper. When the user requests printing a document edited or displayed using the application program, the printer driver outputs information using the currently set printing paper size to the application program together with a printing command. The application program outputs data to the printer driver corresponding to the input printing paper size together with data of the document in response to the printing command. The printer driver converts the input document data to printing data using a format that can be analyzed by the image forming device, and outputs the converted printing data to the image forming device.

In an application program such as a commercial word processor, for example, Microsoft Word or Hangul, users edit a document within an area corresponding to a printing paper size set in the printer driver, thus the portion of a document to be printed is not lost.

However, for web browsers, such as Internet Explorer, or image application programs, such as Photo Shop, which do not have an editing function to set printing paper size, when the size of a document to be printed is greater than the printing paper size currently set in the printer driver, any portion of the document outside the printing paper size is lost when the document is printed.

FIGS. 1A and 1B illustrate conventional printing of a document displayed on a web browser. If a user desires to print a document displayed on a web browser, the printer driver outputs information using the currently set printing paper size, such as A4, to the web browser together with a printing command. The web browser, which receives the printing command, extracts document data of an area corresponding to the A4 size among the document data displayed on the web browser and outputs the extracted document data to the printer driver. The printer driver converts the input document data to printing data, which can be analyzed by the image forming device, and outputs the converted printing data to the image forming device. The image forming device prints a document using the printing data. FIG. 1B is a result obtained by printing the document illustrated in FIG. 1A, the printing result showing that portions 100 and 110 of the document illustrated in FIG. 1A are lost.

As described above, when printing is performed by receiving document data from an application program according to the prior art, a portion of a document that a user desires to print can be unpredictably lost.

### SUMMARY OF THE INVENTION

Accordingly, exemplary embodiments of the present invention provide a printing control method and apparatus for preventing loss of printing data.

According to exemplary embodiments of the present invention, a printing control method is provided that comprises (a) processing a virtual paper size and document data corresponding to the virtual paper size, (b) displaying a document corresponding to the document data and (c) converting the document data of the virtual paper size to printing data of a currently set printing paper size.

In an exemplary implementation, the printing control method may further comprise converting the document data of the virtual paper size to the printing data of the currently set printing paper size in response to selection of the displayed document.

In an exemplary implementation, repeating (a) and (b) until printing of the displayed document is selected.

In an exemplary implementation, the printing control method may further comprise processing document data corresponding to the currently set printing paper size, displaying a document corresponding to the document data, and selecting whether the displayed document is to be printed.

In an exemplary implementation, the document data can be received from a web browser and converted to printing data by being enlarged or reduced according to a ratio of the virtual paper size to the currently set printing paper size.

In an exemplary implementation, the printing control method may be implemented in a printer driver.

According to exemplary embodiments of the present invention, a printing control apparatus is provided that comprises an input unit for processing a virtual paper size, a data input/output unit for processing document data corresponding to the virtual paper size, a display unit for displaying a document corresponding to the document data, and a data converter for converting the document data of the virtual paper size to printing data of a currently set printing paper size.

In an exemplary implementation, the input unit can enable a user to select whether the displayed document is printed, and the data converter can convert the document data of the virtual paper size to the printing data of the currently set printing paper size when printing of the displayed document is selected.

In an exemplary implementation, the printing control apparatus may further comprise a controller for controlling the input unit, the data input/output unit, and the display unit to process document data corresponding to the virtual paper size input from an application program and display a document corresponding to the document data until printing of the displayed document is selected.

In an exemplary implementation, the data input/output unit can receive the document data from a web browser, and the data converter can convert the document data to printing data by enlarging or reducing the document data according to a ratio of the virtual paper size to the currently set printing paper size.

In exemplary embodiments of the present invention, a computer readable medium storing a computer readable program for executing the printing control method is provided.

### BRIEF DESCRIPTION OF THE DRAWINGS

The above and other exemplary features and advantages of the present invention will become more apparent from the following detailed description of certain exemplary embodiments thereof when taken in conjunction with the accompanying drawings, in which:

FIGS. 1A and 1B illustrate conventional printing of a document displayed on a web browser;

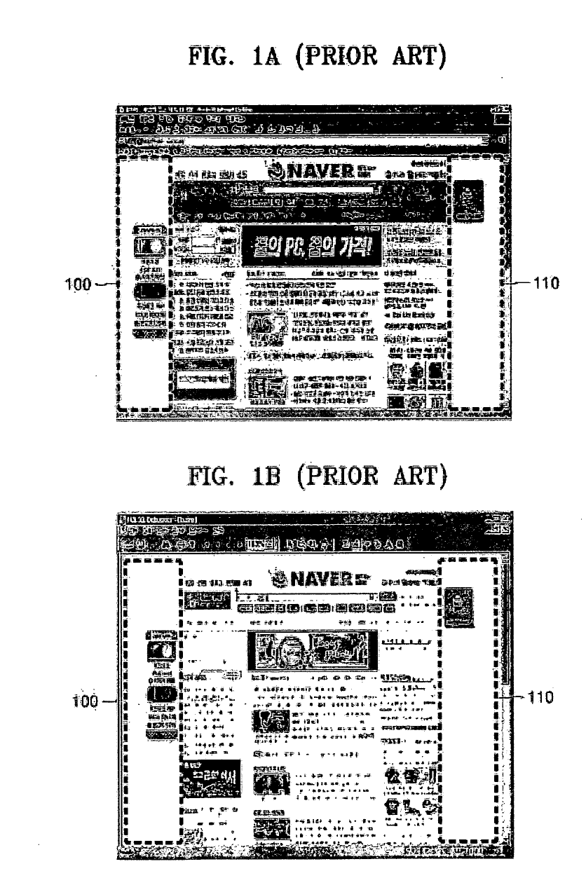

FIG. 2 is a block diagram of a printing control apparatus according to an exemplary embodiment of the present invention;

FIG. 3 is a flowchart of a printing control method according to an exemplary embodiment of the present invention;

FIG. 4 is a flowchart of a printing control method according to another exemplary embodiment of the present invention; and

FIG. 5 is a diagram for explaining a method of converting document data of a virtual paper size to printing data of a printing paper size in accordance with an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

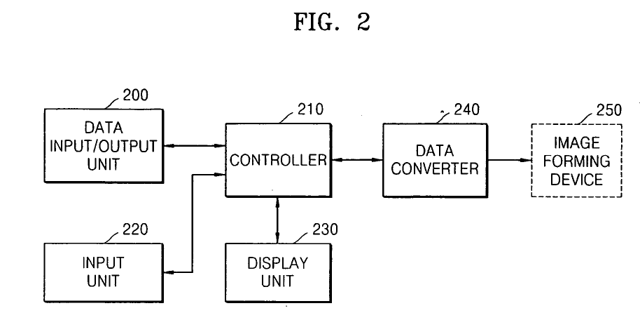

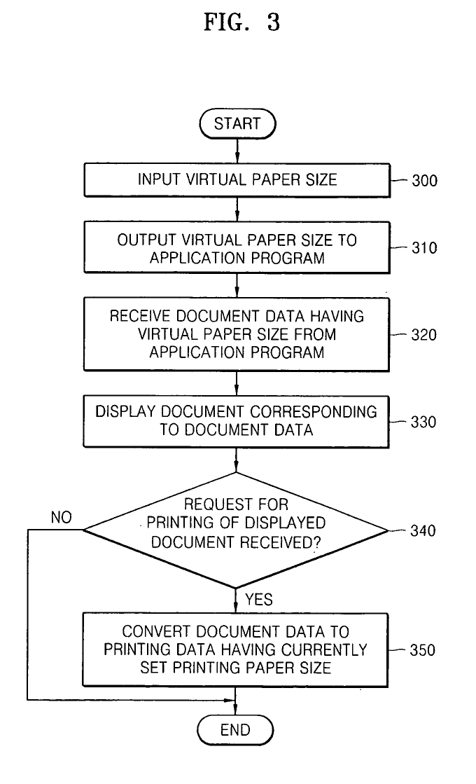

FIG. 2 is a block diagram of a printing control apparatus according to an exemplary embodiment of the present invention. The printing control apparatus includes a data input/output unit 200, a controller 210, an input unit 220, a display unit 230, and a data converter 240. An operation of the printing control apparatus illustrated in FIG. 2 will now be described in conjunction with a flowchart of a printing control method according to an exemplary embodiment of the present invention illustrated in FIG. 3.

The controller 210 controls general operation of the printing control apparatus so that the data input/output unit 200, the input unit 220, the display unit 230, and the data converter 240 perform operations described below. When document printing is requested, the input unit 220 receives a virtual printing paper size corresponding to the size of document area to be printed in step 300. In step 310, the data input/output unit 200 outputs information on the virtual paper size together with a printing command to an application program which, for example, can be used to edit the document.

In step 320, the application program extracts document data corresponding to an area of the virtual paper size from the document, and the data input/output unit 200 receives the document data having the virtual paper size from the application program. In step 330, the display unit 230 displays a document having the virtual paper size using the document data. After the document is displayed, if the input unit 220 receives a request for printing the displayed document in response to a command in step 340, the data converter 240 converts document data corresponding to the virtual paper size to printing data having a printing paper size currently set in a printer driver, step 350. The converted printing data can be analyzed by an image forming device 250. The image forming device 250 performs printing by receiving the converted printing data, wherein, for the printed document, the entire document area is printed on paper having the currently set printing paper size.

In an exemplary embodiment, the application program can be a web browser, such as Internet Explorer or Netscape, which does not have a function to edit the document according to a set printing paper size.

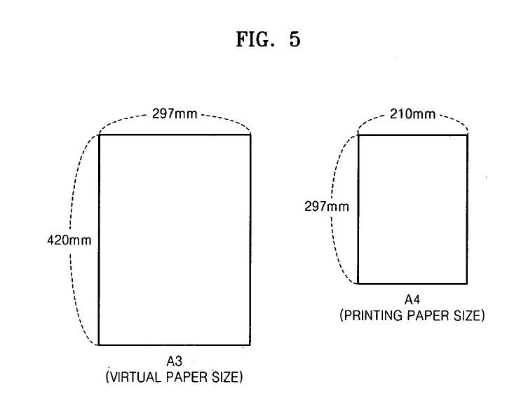

FIG. 5 is a diagram of an example for explaining a method of converting the document data of the virtual paper size to the printing data of the printing paper size according to step 350 of FIG. 3. In the example illustrated by FIG. 5, the virtual paper size selected is A3, and the printing paper size currently set in the printer driver is A4.

The data converter 240 must enlarge or reduce the document data printing size from the virtual paper size to the printing paper size. Methods of determining the enlargement or reduction ratio are described below.

In one exemplary embodiment, after separately calculating a horizontal ratio and a vertical ratio of the virtual paper size to the printing paper size, the greatest value of the calculated ratios can be determined as the enlargement or reduction ratio. For example, when the size of the document data is reduced from the virtual paper size A3 to the printing paper size A4, as illustrated in FIG. 5, the horizontal ratio is 297:210 and the vertical ratio is 420:297. Accordingly, the document data may be reduced by the ratio 297:210, which is the greatest value of the two ratios.

In another exemplary embodiment, after separately calculating a horizontal ratio and a vertical ratio of the virtual paper size to the printing paper size, the horizontal length and the vertical length of the document data can be separately enlarged or reduced. For example, when the size of the document data is reduced from the virtual paper size A3 to the printing paper size A4, as illustrated in FIG. 5, the horizontal length of the document data may be reduced at the ratio 297:210 and the vertical length may be reduced at the ratio 420:297.

The data converter 240 converts the document data converted to the currently set printing paper size to printing data which can be analyzed by the image forming device 250.

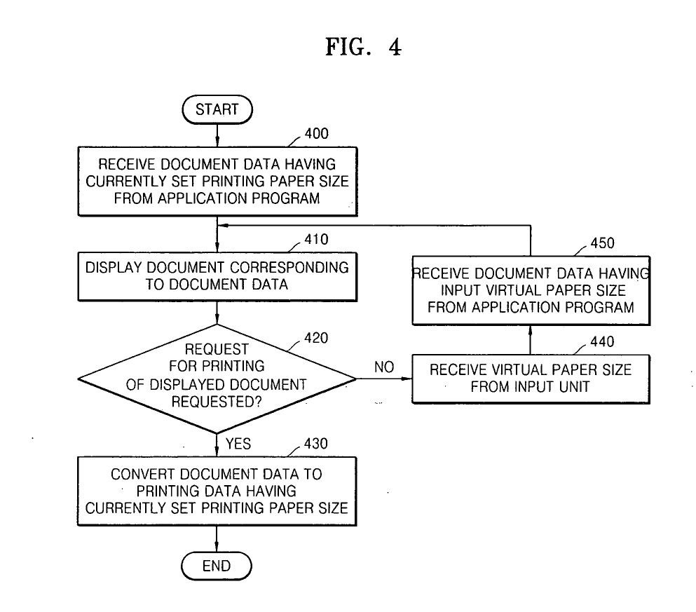

FIG. 4 is a flowchart of a printing control method according to another exemplary embodiment of the present invention. The printing control method illustrated in FIG. 4 will now be described in conjunction with the printing control apparatus illustrated in FIG. 2.

When a document print request occurs, in step 400, the data input/output unit 200 outputs information on a printing paper size currently set in a printer driver together with a printing command to an application program.

In step 410, the application program extracts document data corresponding to an area of the printing paper size from the document, and the display unit 230 displays a document corresponding to the currently set printing paper size using the document data received from the application program via the data input/output unit 200. In step 420, the controller 210 determines whether printing of the displayed document has been requested through the user input unit 220. If the printing request exists, the data converter 240 converts the document data to printing data having a printer paper size currently set in a printer driver, step 430. The converted printing data can be analyzed by the image forming device 250. In this case, since the document data received from the application program has the currently set printing paper size, a process of enlarging or reducing the printing size of the document data is omitted.

If a printing request does not exist for the displayed document, the input unit 220 receives a virtual printing paper size in step 440. In step 450, the data input/output unit 200 provides information on the virtual paper size together with a printing command to the application program and receives document data having the virtual paper size from the application program.

The display unit 230 displays a document having the virtual paper size using the document data in step 410. In step 420, the controller 210 determines whether printing of the displayed document having the virtual paper size has been requested through the user input unit 220. As a result of the determination, if a printing request exists, the data converter 240 converts the document data having the virtual paper size to printing data having the currently set printing paper size in step 430. If a printing request does not exist, the controller 210 controls the data input/output unit 200, the input unit 220, and the display unit 230 to repeat steps 410 through 450 until a printing request of the displayed document exists.

The printing control method according to an exemplary embodiment of the present invention described above may be implemented in a printer driver installed in a host computer such as a PC.

Exemplary embodiments of the invention can also be embodied as computer readable code on a computer readable medium. The computer readable medium can be any data storage device that can store data that can be read by a computer system. Examples of the computer readable media include read-only memory (ROM), random-access memory (RAM), CD-ROMs, magnetic tapes, floppy disks, optical data storage devices, and carrier waves (such as, for example, data transmission through the Internet).

As described above, by using a printing control method and apparatus for preventing loss of printing data according to exemplary embodiments of the present invention, document data can be receiving from an application program according to a virtual paper size using a document previewing function, conversion to printing data of a currently set printing paper size, and printed. Thus, the entire document can be printed and waste of printing paper and working time due to the printing data loss can be reduced.

While the present invention has been particularly shown and described with reference to certain exemplary embodiments thereof, it will be understood by those of ordinary skill in the art that various changes in form and detail may be made therein without departing from the spirit and scope of the present invention as defined by the following claims and equivalents thereof.

What is claimed is:

1. A printing control method for converting document data to printing data, the method comprising:
inputting a virtual paper size;
receiving document data corresponding to the virtual paper size;
displaying a document corresponding to the document data; and
converting the document data of the virtual paper size to printing data of a printing paper size.

2. The method of claim 1, further comprising selectively receiving a print request, wherein, when the print request is received, the document data of the virtual paper size is converted to the printing data of the printing paper size.

3. The method of claim 2, further comprising repeating the printing, the receiving, and the displaying until the print request is received.

4. The method of claim 1, further comprising:
inputting document data corresponding to the printing paper size;
displaying a document corresponding to the document data; and
selectively receiving a print request.

5. The method of claim 1, wherein the document data comprises data from a web browser.

6. The method of claim 1, wherein the document data comprises data converted to printing data by being enlarged or reduced according to a ratio of the virtual paper size to the printing paper size.

7. A printer driver implementing a printing control method as claimed in claim 1.

8. A printing control apparatus for converting document data to printing data, the apparatus comprising:
an input unit for inputting a virtual paper size;
a data input/output unit for receiving document data corresponding to the virtual paper size;
a display unit for displaying a document corresponding to the document data; and
a data converter for converting the document data of the virtual paper size to printing data of a printing paper size.

9. The apparatus of claim 8, wherein the input unit is configured to selectively receive a print request, and
the data converter converts the document data of the virtual paper size to the printing data of the printing paper size when the printing request is received.

10. The apparatus of claim 9, further comprising a controller for controlling the input unit, the data input/output unit, and the display unit to process document data corresponding to the virtual paper size received from an application program and display a document corresponding to the document data.

11. The apparatus of claim 8, wherein the document data comprises data from a web browser.

12. The apparatus of claim 8, wherein the data converter converts the document data to printing data by enlarging or reducing the document data according to a ratio of the virtual paper size to the printing paper size.

13. A printer driver comprising the printing control apparatus of claim 8.

14. A computer readable medium having stored thereon instructions for converting document data to printing data, the instructions comprising:
a first set of instructions for inputting a virtual paper size;
a second set of instructions for receiving document data corresponding to the virtual paper size
a third set of instructions for displaying a document corresponding to the document data; and
a fourth set of instructions for converting the document data of the virtual paper size to printing data of a printing paper size.

15. The instructions of claim 14, further comprising a fifth set of instructions for selectively receiving a print request, wherein, when the print request is received, the document data of the virtual paper size is converted to the printing data of the printing paper size.

16. The instructions of claim 15, further comprising a sixth set of instructions for repeating the printing, the receiving, and the displaying until the print request is received.

17. The instructions of claim 14, further comprising:
a seventh set of instructions for inputting document data corresponding to the printing paper size;
an eighth set of instructions for displaying a document corresponding to the document data; and
a ninth set of instructions for selectively receiving a print request.

18. The instructions of claim 14, wherein the document data comprises data from a web browser.

19. The instructions of claim 14, wherein the document data comprises data converted to printing data by being enlarged or reduced according to a ratio of the virtual paper size to the printing paper size.

20. The method of claim 2, wherein the converted document data is printed.

21. The apparatus of claim 10, wherein the document data is displayed until the print request is received.
